(19) United States
(12) Patent Application Publication
(10) Pub. No.: US 2018/0184452 A1
(43) Pub. Date: Jun. 28, 2018

(54) AVOIDING COLLISIONS OF POSITIONING SIGNALS

(71) Applicant: QUALCOMM Incorporated, San Diego, CA (US)

(72) Inventors: Suresh Kumar BITRA, Mangalagiri (IN); Arun Kumar Sharma TANDRA, Hyderabad (IN); Sreekanth HOSAHUDYA VENKATARAMANAPPA, Hyderabad (IN)

(21) Appl. No.: 15/388,610

(22) Filed: Dec. 22, 2016

(51) Int. Cl. H04W 74/08; H04W 72/04; H04W 64/00

(52) U.S. Cl. CPC H04W 74/085; H04W 88/06; H04W 64/00; H04W 72/0446

(57) ABSTRACT

An example of a method of operating a mobile device includes obtaining positioning signal timing information that indicates a plurality of times when the mobile device will receive positioning signals from one or more base stations associated with a first subscription to a first wireless network; obtaining tune-away information that indicates when a first receiver of the mobile device is scheduled to tune away from the first subscription to receive signals using a second subscription to a second wireless network; and implementing a collision-reduction measure in response to an expected number of collisions meeting a criterion. The expected number of collisions is a number of instances that positioning signals are expected not to be received by the mobile device based on the positioning signal timing information and the tune-away information.

### BACKGROUND

Mobile devices—such as cellular phones, smart phones, tablet computers and laptop computers—may include multiple subscriber identity modules (SIM) and therefore allow the mobile device to communicate via multiple subscriptions to respective different wireless networks. Such a device is referred to as a “multi-SIM device.” Each SIM is associated with a respective subscription, which is an arrangement (e.g., a paid agreement) that gives the mobile device access to a particular carrier's network to enable the sending and receiving of multimedia data and voice information. The SIM stores subscription information that is used by the mobile device to authenticate the SIM on the respective wireless network. A multi-SIM device where the multiple SIMs share a transceiver for communicating with their respective networks is referred to as a “multi-SIM-multi-standby device.” An example is a device with two SIMs, referred to as a “dual-SIM-dual-standby (DSDS) device.”

In a DSDS device, only one subscription is active at a given time and the two subscriptions share a single receiver, referred to as the primary receiver (PRx). When a first subscription is in an active mode, the second subscription is in an idle mode. While the second subscription is in idle mode, the mobile device periodically checks the second subscription for page message (e.g., to determine if there is an incoming call). This is done by briefly tuning the PRx away from a channel associated with the first subscription to a channel associated with the second subscription to receive an incoming page message. The PRx is tuned away to the channel associated with the second subscription on a periodic basis. The UE process of monitoring for discontinuous, periodic page messages is referred to as Discontinuous Reception (DRx). The periodic cycle the UE uses to monitor for the page messages is referred to as the DRx cycle. is said.

In addition to sending and receiving multimedia data and voice information with a wireless network, a mobile device may also be configured to perform positioning techniques to determine the location of the mobile device. For example, multilateration techniques may be used to determine the location of the mobile device. Performing multilateration requires the mobile device to receive and analyze signals from multiple known locations. In some positioning techniques, the base stations of the wireless networks with which the mobile device communicates. One example of a positioning technique that uses multilateration is Observed Time Difference Of Arrival (OTDOA), which uses measurements of the difference in arrival times of positioning signals (e.g., positioning reference signals (PRS)) received by the mobile device from the multiple base stations. A multi-SIM device may perform OTDOA using any of the available subscriptions.

### SUMMARY

An example of a method of operating a mobile device includes obtaining positioning signal timing information that indicates a plurality of times when the mobile device will receive positioning signals from one or more base stations associated with a first subscription to a first wireless network; obtaining tune-away information that indicates when a first receiver of the mobile device is scheduled to tune away from the first subscription to receive signals using a second subscription to a second wireless network; and implementing a collision-reduction measure in response to an expected number of collisions meeting a criterion. The expected number of collisions is a number of instances that positioning signals are expected not to be received by the mobile device based on the positioning signal timing information and the tune-away information.

Implementations of such a method may include one or more of the following features. Implementing the collision-reduction measure may include using a second receiver, separate from the first receiver, to receive at least some of the positioning signals. Using the second receiver to receive at least some of the positioning signals may include receiving at least some of the positioning signals with a carrier aggregation receiver. Using the second receiver to receive at least some of the positioning signals may include receiving, with the second receiver, positioning signals expected not to be received by the mobile device due to the first receiver being tuned away from the first subscription. The method may further include receiving at least one other positioning signal with the first receiver. Using the second receiver to receive at least some of the positioning signals may include receiving, with the second receiver, positioning signals expected not to be received by the mobile device due to the first receiver being tuned away from the first subscription and positioning signals expected to be received by the first receiver.

Implementations of such a method may also include one or more of the following features. Obtaining the tune-away information may include receiving discontinuous reception cycle information for the second subscription. Implementing the collision-reduction measure may include using a radio access technology for the second subscription other than a radio access technology for which the tune-away information is obtained. The expected number of collisions may be a first expected number of collisions for use of a first radio access technology for the second subscription, and the expected number of collisions meeting the criterion may include the expected number of collisions being greater than a first threshold. Implementing the collision-reduction measure may include using the first receiver and a second radio access technology, different from the first radio access technology, for the second subscription in response to a second expected number of collisions, expected if the mobile device uses the second radio access technology for the second subscription, being less than a second threshold; and receiving at least some of the positioning signals with a second receiver, separate from the first receiver, in response to the second expected number of collisions being greater than the second threshold.

An example of a mobile device includes a first receiver configured to wirelessly receive signals from a first wireless network using a first subscription and/or a second wireless network using a second subscription; a processor, communicatively coupled to the first receiver, configured to: obtain positioning signal timing information that indicates a plurality of times when the mobile device will receive positioning signals from one or more base stations associated with the first subscription to the first wireless network; obtain tune-away information that indicates when the first receiver of the mobile device is scheduled to tune away from the first subscription to receive signals using a second subscription to the second wireless network; and implement a collision-reduction measure in response to an expected number of collisions meeting a criterion. The expected number of collisions is a number of instances that positioning signals are expected not to be received by the mobile device based on the positioning signal timing information and the tune-away information.

Implementations of such a mobile device may include one or more of the following features. The mobile device may include a second receiver, separate from the first receiver. The processor may be configured to implement the collision-reduction measure by using the second receiver to receive at least some of the positioning signals. The second receiver may include a carrier aggregation receiver. The second receiver may be configured to receive positioning signals expected not to be received by the mobile device due to the first receiver being tuned away from the first subscription, and the first receiver may be configured to receive at least one other positioning signal. The second receiver may be configured to receive positioning signals expected not to be received by the mobile device due to the first receiver being tuned away from the first subscription and positioning signals expected to be received by the first receiver.

Implementations of such a mobile device may also include one or more of the following features. The processor may be configured to obtain the tune-away information by receiving discontinuous reception cycle information for the second subscription. The processor may be configured to implement the collision-reduction measure by using a radio access technology for the second subscription other than a radio access technology for which the tune-away information is obtained. The expected number of collisions may be a first expected number of collisions for use of a first radio access technology for the second subscription, and the expected number of collisions meeting the criterion may include the expected number of collisions being greater than a first threshold. The processor may be further configured to implement the collision-reduction measure by: causing the first receiver to use a second radio access technology, different from the first radio access technology, for the second subscription in response to a second expected number of collisions, expected if the mobile device uses the second radio access technology for the second subscription, being less than a second threshold; and causing a second receiver, separate from the first receiver, to receive at least some of the positioning signals in response to the second expected number of collisions being greater than the second threshold.

An example of a mobile device includes a first receiving means for wirelessly receiving signals from a first wireless network using a first subscription and/or a second wireless network using a second subscription; timing obtaining means for obtaining positioning signal timing information that indicates a plurality of times when the mobile device will receive positioning signals from one or more base stations associated with a first subscription to the first wireless network; tune-away obtaining means for obtaining tune-away information that indicates when the first receiving means of the mobile device is scheduled to tune away from the first subscription to receive signals using a second subscription to the second wireless network; and prevention means for implementing a collision-reduction measure in response to an expected number of collisions meeting a criterion. The expected number of collisions is a number of instances that positioning signals are expected not to be received by the mobile device based on the positioning signal timing information and the tune-away information.

Implementations of such a mobile device may include one or more of the following features. The mobile device may include a second receiving means, separate from the first receiving means. The prevention means may implement the collision-reduction measure using the second receiving means to receive at least some of the positioning signals. The second receiving means may include a carrier aggregation receiving means. The second receiving means is for receiving positioning signals expected not to be received by the mobile device due to the first receiving means being tuned away from the first subscription. The first receiving means may receive at least one other positioning signal. The second receiving means may be configured to receive positioning signals expected not to be received by the mobile device due to the first receiving means being tuned away from the first subscription and positioning signals expected to be received by the first receiving means.

Implementations of such a mobile device may also include one or more of the following features. The prevention means may include radio-access-technology means for using a radio access technology for the second subscription other than a radio access technology for which the tune-away information is obtained. The expected number of collisions may be a first expected number of collisions for use of a first radio access technology for the second subscription, and the expected number of collisions meeting the criterion may include the expected number of collisions being greater than a first threshold. The prevention means may be further for: causing the first receiving means to use a second radio access technology, different from the first radio access technology, for the second subscription in response to a second expected number of collisions, expected if the mobile device uses the second radio access technology for the second subscription, being less than a second threshold; and causing a second receiving means, separate from the first receiving means, to receive at least some of the positioning signals in response to a determination that the second expected number of collisions being greater than the second threshold.

An example of a non-transitory, processor-readable storage medium includes processor-readable instructions configured to cause a processor of a device to obtain positioning signal timing information that indicates a plurality of times when the mobile device will receive positioning signals from one or more base stations associated with a first subscription to a first wireless network; obtain tune-away information that indicates when a first receiver of the mobile device is scheduled to tune away from the first subscription to receive signals using a second subscription to a second wireless network; and implement a collision-reduction measure in response to an expected number of collisions meeting a criterion. The expected number of collisions is a number of instances that positioning signals are expected not to be received by the mobile device based on the positioning signal timing information and the tune-away information.

Implementations of such a non-transitory, processor-readable storage medium may include one or more of the following features. The instructions configured to cause the processor to implement the collision-reduction measure may include instructions configured to cause the processor to use a second receiver, separate from the first receiver, to receive at least some of the positioning signals. The instructions configured to cause the processor to use a second receiver to receive at least some of the positioning signals may include instructions configured to cause the processor to receive at least some of the positioning signals with a carrier aggregation receiver. The instructions configured to cause the processor to use a second receiver to receive at least some of the positioning signals may include instructions configured to cause the processor to receive, with the second receiver, positioning signals expected not to be received by the mobile device due to the first receiver being tuned away from the first subscription. The non-transitory, processor-readable storage medium may further include instructions configured to cause the processor to receive at least one other positioning signal with the first receiver. The instructions configured to cause the processor to use a second receiver to receive at least some of the positioning signals may include instructions configured to cause the processor to receive, with the second receiver, positioning signals expected not to be received by the mobile device due to the first receiver being tuned away from the first subscription and positioning signals expected to be received by the first receiver.

Implementations of such a non-transitory, processor-readable storage medium may also include one or more of the following features. The instructions configured to cause the processor to implement the collision-reduction measure may include instructions configured to cause the processor to use a radio access technology for the second subscription other than a radio access technology for which the tune-away information is obtained. The expected number of collisions may be a first expected number of collisions for use of a first radio access technology for the second subscription, and the expected number of collisions meeting the criterion may include the expected number of collisions being greater than a first threshold. The instructions configured to implement the collision-reduction measure may include: instructions configured to cause the processor to use the first receiver and a second radio access technology, different from the first radio access technology, for the second subscription in response to a second expected number of collisions, expected if the mobile device uses the second radio access technology for the second subscription, being less than a second threshold; and instructions configured to cause the processor to receive at least some of the positioning signals with a second receiver, separate from the first receiver, in response to the second expected number of collisions being greater than the second threshold.

### BRIEF DESCRIPTION OF THE DRAWINGS

Non-limiting and non-exhaustive examples of methods and systems are described with reference to the following figures. The figures may not be drawn to scale.

FIG. 1 is a simplified diagram of an example communications environment.

FIG. 2 is a block diagram of an example mobile device that may operate in the communications environment of FIG. 1

FIG. 3 is a simplified signal timing diagram of an example set of signals received by a mobile device.

FIG. 4 is a flow diagram of an example method of operating the mobile device of FIG. 3.

FIG. 5 is a flow diagram of another example method of operating the mobile device the device of FIG. 2.

### DETAILED DESCRIPTION

Items and/or techniques described herein may provide improved location accuracy and shorter times to determining an initial location solution. These improved capabilities may be achieved by avoiding collisions between positioning signals on a first subscription and page messages on a second subscription. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

Techniques are discussed herein for implementing collision-reduction measures to reduce the number of collisions between positioning signals on a first subscription and page messages on a second subscription of a mobile device. A subscription that is in “idle mode” is not actively communicating voice or data plan information for the use, but instead repeats a DRx cycle, each cycle lasting for a predetermined amount of time. An example of an idle mode is Radio Resource Control (RRC) idle mode in a long term evolution (LTE) network. During a first phase of each DRx cycle, the subscription is not communicating with the network. At the end of each DRx cycle, the subscription enters a second phase where the mobile device performs an idle mode wakeup at which point the mobile device temporarily resumes contact with the network associated with the idle subscription in order to receive network information via a page message before beginning the next DRx cycle. The network information received by the mobile device is used to perform idle mode operations that allow the subscription to remain synchronized with the network. The page message may also include information about an incoming call to the mobile device via the idle subscription. In contrast, a subscription that is in “active mode” is actively, but not necessarily continuously, communicating information with an associated network. This information could be voice data or data requested by the user associated with the subscription's data plan. An example of an active mode is RRC active mode in an LTE network. The information communicated while in active mode also includes positioning signals used to determine the location of the mobile device. Receiving page messages of an idle second subscription is a higher priority action for a mobile device than receiving positioning signals of an active first subscription because the paging messages include information about whether there is an incoming telephone call on the second subscription and information necessary to keep the mobile device synchronized with the network associated with the second subscription. Receiving the positioning signals, on the other hand, is a lower priority action because positioning techniques can still be performed even when multiple positioning signals are not received by the mobile device. Consequently, when a positioning signal for the active first subscription is expected to be received at the same time as a page message for the idle second subscription, the mobile device tunes the receiving channel of the primary receiver to correspond to the channel used to receive the page message rather than tuning the receiving channel of the primary receiver to the channel used for receiving the positioning signal. The term “channel” is used herein to mean a frequency band to which a receiver can be tuned to receive radio frequency (RF) signals from one or more base stations. As used herein, the term “collision” refers to an instance when a positioning signal is not received by the mobile device, e.g., because the primary receiver is tuned away to a different channel to receive a page message. By reducing the number of collisions, the mobile device may improve location accuracy and the “first fix time,” which is an amount of time used by a positioning technique to determine an initial location solution.

To reduce the number of collisions, the mobile device determines when collisions are expected to occur using information about timing of various signals on the two subscriptions. The mobile device receives information about the expected timing of the positioning signals for the first subscription and the expected timing of the page messages for the second subscription. For example, in response to initiating a positioning protocol with a first wireless network using the first subscription, the mobile device may receive assistance data from a location server associated with the wireless network. The assistance data includes positioning signal timing information indicating the expected times when positioning signals are expected to be sent from a serving base station and other nearby base stations, which typically can be assumed to be the expected times of receipt of the signals by the mobile device. The assistance data also includes channel information indicating on which channel the positioning signals are expected to be received. Similarly, in response to initiating a connection with a second wireless network using the second subscription, an indication of the DRx cycle is sent to the mobile device. The indication of the DRx cycle indicates the periodicity, timing offset and width of the expected page messages. Using the expected timing of the positioning signals and the expected timing of the page messages, the mobile device can determine, a priori, when collisions are expected to occur.

The mobile device can implement a collision-reduction measure, in response to determining the expected collisions, to attempt to reduce the number of expected collisions. The mobile may implement the collision-reduction measure in response to the expected collisions meeting a criterion, such as the number of expected collisions exceeding a threshold. The collision-reduction measure may have the advantage of being controlled by the mobile device without requiring changes to the wireless network relative to conventional network operation. The collision-reduction measure may, for example, include altering the DRx cycle, which can be achieved by the mobile device changing the radio access technology used to communicate with the second wireless network via the idle second subscription. Alternatively, the collision-reduction measure may include using an additional receiver, other than the PRx, that is a component of the mobile device. For example, a carrier aggregation (CA) receiver may be used to receive some of the positioning signals for the first subscription or all of the positioning signals for the first subscription.

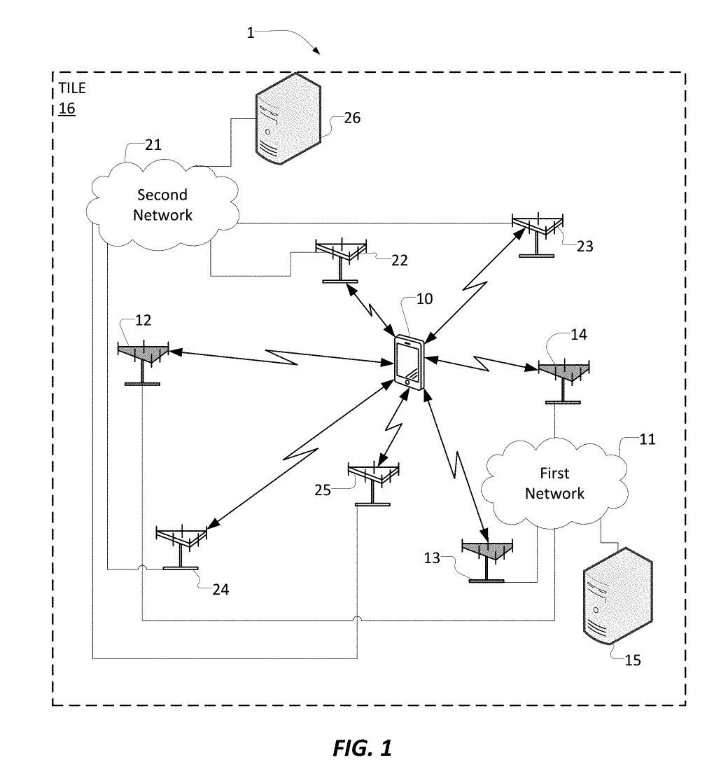

Referring to FIG. 1, a mobile device 10 is configured to communicate with multiple base stations in a communications environment 1, which includes a first network 11 and a second network 21. The two networks are cellular communications networks that allow the mobile device 10 to send and receive telephone calls and data. Base stations 12-14 are used by the first network 11 to wirelessly send information to and receive information from the mobile device 10 using a first subscription, and base stations 22-25 are used by the second network 21 to wirelessly send information to and receive information from the mobile device 10 using a second subscription. The base stations 12-14 are communicatively coupled to the first network 11 using, for example, a physical connection, such as a wired or optical connection. The base stations 22-25 are communicatively coupled to the second network 21 using, for example, a physical connection, such as a wired or optical connection.

The mobile device 10 is configured to transmit RF signals to, and receive RF signals from, the base stations 12-14 using the first subscription, and transmit RF signals to, and receive RF signals from, the base stations 22-25 using the second subscription. Each of the base stations 12-14, 22-25 may be a wireless base transceiver station (BTS), a Node B, an evolved NodeB (eNB), a femtocell, a Home Base Station, a small cell base station, a Home Node B (HNB), or a Home eNodeB (HeNB). The first network 11 and the second network 21 may be a 2G, a 3G, a 4G, or a 5G network, or be hybrid networks (e.g., a 3G/4G network). The first network 11 need not be the same type of network as the second network. The first network 11 and the second network 21 are operated by different carriers (e.g., Verizon, AT&T, T-Mobile, Sprint, etc.). The mobile device 10 may communicate to the two networks using a radio access technology (RAT), such as the Global System for Mobile Communications (GSM), code division multiple access (CDMA), wideband CDMA (W-CDMA), Time Division CDMS (TD-CDMA), Time Division Synchronous (TD-SCDMA), CDMA2000, High Rate Packet Data (HRPD, or LTE. These are examples of network technologies that may be used to communicate with the mobile device 10 over a wireless link, and claimed subject matter is not limited in this respect. GSM, WCDMA and LTE are technologies defined by 3GPP. CDMA and HRPD are technologies defined by the 3rd Generation Partnership Project 2 (3GPP2). WCDMA is also part of the Universal Mobile Telecommunications System (UMTS) and may be supported by a HNB. Additionally, both the first network 11 and the second network 21 may support more than one RAT. For example, the first network 11 may communicate with the mobile device 10 using W-CDMA and LTE. Further, while three base stations are illustrated in FIG. 1 for the first network 11 and four base stations are illustrated for the second network 21, different numbers of base stations may exist in particular regions.

The mobile device 10 receives a variety of wireless signals from base stations 12-14 and base stations 22-25. One base station per network is designated as the primary base station for communication with the mobile device 10. The primary base station (sometimes referred to as the serving base station or the serving cell) is the base station with which the mobile device 10 manages the communication with the network. For example, the base station 14 may be the primary base station for the first network 11 and the base station 25 may be the primary base station for the second network 21.

The base station 14 sends assistance data to the mobile device 10. The assistance data includes information about the positioning signals that the mobile device 10 is expected to receive from the other base stations 12-13 for the first network 11. The assistance data includes at least the identity of the other base stations, the channel that each base station will use to send the positioning signal, and the time at which the positioning signal is expected to be received. The time may be an indication of a location within a frame or a time defined by clock of the base station 14 that is synchronized with a clock of the mobile device 10. In the case of OTDOA, the positioning signals are positioning reference signals (PRS), as defined by the LTE standard. The assistance data for OTDOA is sent from a location server 15 for the first network 11 or a location server 26 for the second network 21. Information about the location of the base stations that are expected to send the PRS signals is not included in the OTDOA assistance data because the determination of the location of the mobile device 10 using OTDOA occurs on the network-side, not on the mobile device 10.

The mobile device 10 may make time difference measurements that are used by the location server 15 to determine the location, but the positioning techniques used by the mobile device are not limited to OTDOA. For example, positioning protocols such as the terrestrial downlink positioning (TDP) of Qualcomm® may be used to determine the location of the mobile device 10 based on a time-of-arrival and/or time-difference-of-arrival of positioning signals from multiple nearby base stations. TDP differs from OTDOA in several ways. First, the location determination is performed by the mobile device 10. Thus, the assistance data sent to the mobile device 10 for TDP includes the location of the base stations. Second, TDP is not limited to using signals from base stations operated by a single carrier. In contrast to the location server 15 used for OTDOA, which only sends assistance data for base stations associated with the first network 11, a server used to send TDP assistance data to the mobile device 10 can send information about base station operated by other carriers. In this way, the number of base stations available for positioning is increased. The TDP assistance data is referred to as “tile data.” The mobile device 10 receives assistance data for all the base stations within the “tile” 16 the mobile device 10 occupies. The tile may be a 1 km by 1 km square. The mobile device 10 may also receive assistance data for neighboring tiles.

In addition to receiving assistance data from the primary base station 14 for the first network 11, the mobile device 10 also receives DRx cycle information for the second network 21, which the mobile device 10 communicates with using the second, idle subscription. The DRx cycle information includes a periodicity (e.g., how often a page message is expected to be sent), a timing offset (e.g., when the page message arrives relative to a reference time) and a duration of the page message (e.g., the “width” of the page message). Alternatively, the DRx cycle information may include actual times that the page messages are expected to arrive relative to a reference time. For example, the DRx cycle information may include a frame and sub-frame number indicating when one or more page messages are expected to arrive at the mobile device 10.

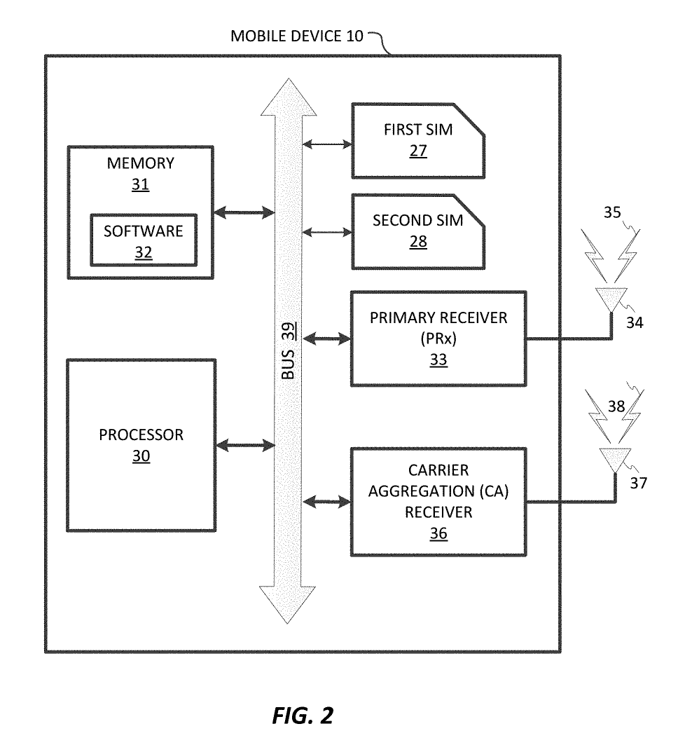

Referring to FIG. 2, with further reference to FIG. 1, an example of a mobile device 10 includes a processor 30, a memory 31, software 32, a first SIM 27, a second SIM 28, a primary receiver (PRx) 33, and a carrier aggregation (CA) receiver 36. The device 10 is a computer system that may be a handheld mobile device, such as a mobile phone or smart phone. The processor 30 is an intelligent device, e.g., a central processing unit (CPU), a microcontroller, an application specific integrated circuit (ASIC), etc. The processor 30 may, for example, include an image signal processor (ISP). The memory 31 is a non-transitory, processor-readable memory that stores instructions that may be executed by processor 30 and includes random access memory (RAM), read-only memory (ROM) and non-volatile memory such as flash memory or solid state storage. The software 32 can be loaded onto the memory 31 by being downloaded via a network connection, uploaded from a disk, etc. Further, the software 32 may not be directly executable, e.g., requiring compiling before execution. The software 32 includes instructions configured to cause the processor 30 to perform functions described herein.

The first SIM 27 and the second SIM 28 are separate and distinct SIMs that are configured to provide access to a first subscription associated with the first network 11 and a second subscription associated with the second network 21, respectively. The SIMs may be, for example, a Universal Integrated Circuit Card (UICC) and may include a processor, ROM, RAM, Electrically Erasable Programmable Read-Only Memory (EEPROM) and/or circuitry. The first SIM 27 and the second SIM 28 are configured to store user account information, an international mobile subscriber identity (IMSI), SIM application toolkit (SAT) command instructions, and storage space for additional information, such as telephone book contact information.

The various components of the mobile device 10 are communicatively coupled to one another via a bus 39, which is configured to transmit information from one component to another component. For example, the processor 30 is communicatively coupled to the first SIM 27, the second SIM 28, the PRx 33, the CA receiver 36, and the memory 31 via the bus 39, which allows the processor 30 to receive and process information received from a wireless network via the receivers. The processor 30 is configured to send commands to the first SIM 27 and the second SIM 28 via the bus 39 and the SIMs 27, 28 are configured to send information, such as the IMSI to the processor 30. The processor 30 is further configured to send information to the PRx 33 and the CA receiver 36, such as a message that includes the IMSI of one of the SIMs 27, 28, via the bus 39 for wireless transmission by the PRx 33 or the CA receiver 36. The PRx 33 and the CA receiver 36 are also configured to send messages wirelessly received from a base station of a wireless network to the processor 30.

The PRx 33 is configured to wirelessly receive signals 35 via an antenna 34 from base stations. The CA receiver 36 is configured to wirelessly receive signals 38 from base stations via an antenna 37. In a DSDS device, both the PRx 33 and the CA receiver 36 are configured to receive signals from respective wireless networks using a first subscription and/or a second subscription.

The CA receiver 36 is configured to wirelessly receive signals from a first wireless network associated with a first SIM and/or a second wireless network associated with a second SIM. The mobile device 10 may include more than one CA receiver 36, though only the single CA receiver 36 is illustrated. The CA receiver 36 is conventionally reserved for applications where increased bandwidth is desired. For example, if a user of the mobile device 10 is downloading a video or an audio file, the number of bits received by the mobile device 10 may be increased by operating the CA receiver 36 in parallel with the PRx 33. This parallel operation of multiple receivers is referred to as “carrier aggregation.” When carrier aggregation is used, the primary base station assigns secondary carrier components (CC), which are additional channels for transmitting information to the mobile device. The CC channels may be utilized by the primary base station or other neighboring base stations. When the number of CC channels increases, the number of receivers used by the mobile device increases due to there being a one-to-one correspondence between the number of receivers and the number of base stations. For example, a wireless network may determine that it is sending a large file to the mobile device 10 and therefore activate carrier aggregation. The wireless network uses the primary base station to send information about the CA connection to the PRx 33 of the mobile device 10. The mobile device 10 and the wireless network then establish a connection between the CA receiver 36 and a CC channel associated with a secondary base station of the wireless network. The mobile device 10 then receives the file via both the PRx 33 and the CA receiver 36, in parallel, thereby decreasing the amount of time required to receive the file. The CA receiver 36 differs from the PRx 33 in that the CA receiver 36 never acts as the primary receiver for managing the mobile device's connection to the primary base station of the wireless network.

Both the PRx 33 and the CA receiver 36 are tunable receivers that can receive signals on multiple different frequency bands, referred to as channels. The PRx 33 is configured to receive signals from a primary base station on a first channel, but is also configured to tune away to other channels when signals are expected to be received from other base stations. Tuning away the PRx 33 from a channel associated with a first subscription to a first wireless network to receive information on a different channel associated with a second subscription to a second wireless network can cause collisions, where positioning signals sent by base stations associated with the first subscription are not received by the PRx 33. For example, when a page message is expected to be received from the second wireless network associated with the second subscription in accordance with the DRx cycle, the PRx 33 tunes away from the channel used to receive positioning signals from the first network associated with the first subscription.

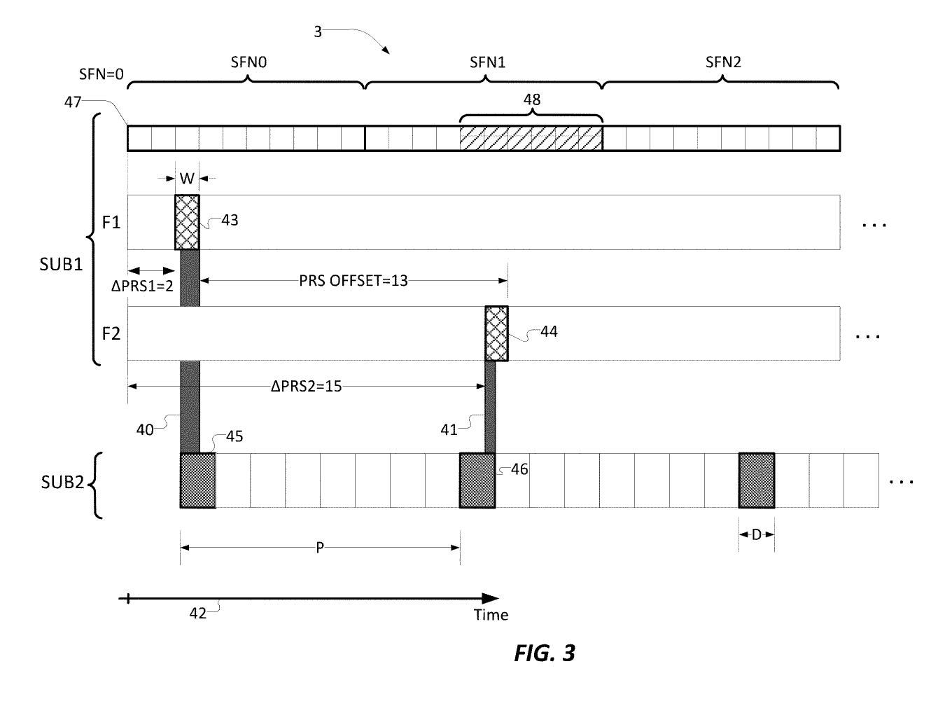

Referring to FIG. 3, with further reference to FIGS. 1-2, a first collision 40 and a second collision 41 are illustrated within a signal timing diagram 3 for the device 10, which is a DSDS device, where a time axis 42 indicates that time is represented by the horizontal direction. While time is continuous along the time axis 42, it is conventional to describe the timing of signals with respect to system frame numbers (SFNs) and sub-frames. The SFNs and sub-frames are illustrated by the blocks 47 at the top of FIG. 3. Each SFN has a duration of 10 ms and includes ten sub-frames, each sub-frame having a duration of 1 ms. The timing of particular signals may be referred to by the timing of the signals within this SFN/sub-frame frame work. For example, as discussed below, PRS 43 occurs at the third sub-frame of SFN0.

The example illustrated in FIG. 3 is based on using OTDOA as the positioning technique. Thus, the positioning signals are PRS. A first subscription SUB1 of the DSDS device 10 is in an active mode and is used to receive a PRS 43 from a primary base station on a first channel associated with a first frequency F1 and a PRS 44 from a secondary base station on a second channel associated with a second frequency F2. For the sake of clarity, only two channels are shown for the first subscription SUB1, but additional channels could be used for PRS from other base stations. The PRS 43 and the PRS 44 are transmitted from base stations at set positions within the SFN. The PRS 43 occurs at the third sub-frame of SFN0, and the PRS 44 occurs at the sixth sub-frame of SFN1. In other words, the number of sub-frames from time t=0 to PRS 43 is ΔPRS1=2 sub-frames and the number of sub-frames from time t=0 to PRS 44 is ΔPRS2=15 sub-frames. The parameter ΔPRS for a particular channel is referred to as the sub-frame offset. The distance between PRS 43 and PRS 44, i.e., the number of sub-frames between the two PRSs (referred to as the PRS offset), is determined by the first network 11 to ensure that there are no collisions between PRSs on different channels. In this case, the PRS offset is 13 sub-frames. The PRS 43 and the PRS 44 have a duration, w, which in this example is equal to a single sub-frame. However, the duration, w, can be multiple consecutive sub-frames in duration. For example, the PRS duration, w, can be 1, 2, 4 or 6 sub-frames.

When the PRS 44 is about to arrive at the mobile device 10, the PRx 33 is tuned to the second channel using frequency F2. For some time before and after the PRS 44 arrives, the PRx 33 cannot receive signals on the first channel using frequency F1. This tune-away duration from the first channel to detect a PRS on a different channel is referred to as a measurement gap. The measurement gap is a greater number of sub-frames than the PRS 44, which is only one sub-frame in duration, because there is some uncertainty in when the mobile device 10 will actually receive the PRS 44. Thus, the mobile device 10 tunes the PRx 33 to receive signals on the second channel for longer than the actual duration of the expected signal. The measurement gap is represented by the sub-frame blocks 48, illustrated with a diagonal line fill. While only a single PRS is illustrated for each channel of the first subscription SUB1 in FIG. 3, PRSs are transmitted by base stations with a certain periodicity selected by the first network 11. The period, T is defined in 3GPP TS 36.211 and can be equal to 160, 320, 640 or 1280 sub-frames.

The PRS transmission schedule for a given channel of the first network 11 can be completely determined based on three parameters: the periodicity, T; the PRS duration, w; and the sub-frame offset, ΔPRS. These parameters are provided to the mobile device 10 as part of the assistance data received from location server 15.

The second subscription SUB2 of mobile device 10 is in idle mode, which allows the mobile device 10 to reduce power consumption by only using the second subscription SUB2 to receive page messages, such as a page message 45 and a page message 46, which may provide an indication of an incoming telephone call. The page messages are sent by base stations for the second network 21 with a certain periodicity, P, and each individual page message has a prescribed duration, D. The period, P, and the duration, D, are determined when the wireless connection between the mobile device 10 and the second network 21 is established and may be dependent on the RAT used to communicate with the second network 21. For example, a DRX cycle using LTE may have a period of 32 ms, 64 ms, 128 ms, or 256 ms, the DRX cycle for WCDMA may have a period of 40 ms, 80 ms, 320 ms, 640 ms, 1.28 s or 2.56 s, and the DRX cycle for GSM may have a period of 470.769 ms, 706.154 ms, 941.538 ms, 1.176923 s, or 1.412308 s. The aforementioned periods are provided by way of example and not limitation. Other DRX cycle periods may be used.

The timing/positioning of the page message 45 and the page message 46 received using the second subscription SUB2 is independent from the SFN/sub-frame framework for the first subscription SUB1 because the two subscriptions are associated with different networks that are likely operated by different carriers. Thus, collisions may result where a page message causes the PRx 33 of mobile device 10 to tune away from the channel associated with the first subscription SUB1. Collisions not only occur when the timing of a page message of the second subscription SUB2 exactly coincides with the timing of the PRS of the first subscription SUB1, but also occur when there is any overlap at all between the PRS and the page message. For example, PRS 43 may be partially received by the PRx 33, but will tune away after only partial reception of PRS 43 in order to receive page message 45, thereby creating the collision 40. Similarly, even though the later portion of PRS 44 could be received by the PRx 33, the earlier portion of PRS 44 cannot be received by the mobile device 10 because the PRx 33 is tuned away to receive the page message 46, thereby creating the collision 41.

The processor 30 is configured to obtain positioning signal timing information that indicates a plurality of times when the mobile device will receive positioning signals from one or more base stations associated with a first subscription to a first wireless network. The PRx 33 may be configured to receive the positioning signal timing information from the primary base station 14 associated with the first subscription. The positioning signal timing information may be received as part of assistance data sent to the mobile device 10 to assist in positioning techniques, such as OTDOA or TDP. For example, the PRx 33 may be configured to receive, from the location server 15, OTDOA assistance data that provides information about the PRS expected to be received from base stations associated with the first subscription near the mobile device 10. Alternatively or additionally, the PRx 33 may be configured to receive, from a server other than the location server 15 (e.g., a third party server that stores information about the positioning signals), TDP assistance data (e.g., TDP tile information) that provides information about positioning signals being broadcast by base stations associated the first network 11 as well as positioning signals being broadcast by networks operated by a carrier other than the carrier of the first network 11. For example, if the first network 11 is a first LTE network operated by a first carrier and there is a second LTE network operated by a second carrier with base stations sending positioning signals near the mobile device 10, then the TDP assistance data may include information about the positioning signals of the first LTE network and the positioning signals of the second LTE network.

Once received via the PRx 33, the positioning signal timing information may be stored in the memory 31. The processor 30 may be configured to obtain the positioning timing information by retrieving the information from the memory 31. The positioning signal timing information includes information about the timing of the positioning signals expected to be received by the mobile device 10 from multiple base stations near the mobile device 10. For example, if the positioning signals are PRS, the positioning signal timing information, may include the periodicity, T; the PRS duration, w; and the sub-frame offset, ΔPRS for multiple base stations near the mobile device 10.

The processor 30 is further configured to obtain tune-away information that indicates when the first receiver of the mobile device is scheduled to tune away from the first subscription to receive signals using a second subscription to a second wireless network. The first receiver may be the PRx 33. The PRx 33 may be configured to receive the tune-away information from the primary base station 25 associated with the second subscription. The tune-away information may be received by the PRx 33 while establishing a connection with a base station associated with the second subscription. The tune-away information may be timing information about the DRX cycle for the idle second subscription.

Once received via the PRx 33, the positioning signal timing information may be stored in the memory 31. The processor 30 may be configured to obtain the tune-away information by retrieving the information from the memory 31. The tune-away information includes information about the timing of the page messages expected to be received by the mobile device 10 from the primary base station 25 for the second network 21. By way of example and not limitation, the tune-away information may include information about the periodicity, duration and offset of page messages expected to be received from a base station for the second network 21.

The processor 30 may be further configured to implement a collision-reduction measure in response to an expected number of collisions meeting a criterion, the expected number of collisions being a number of instances that positioning signals are expected not to be received by the mobile device based on the positioning signal timing information and the tune-away information. Implementing the collision-reduction measure results in an actual number of collisions that is less than the expected number of collisions. The processor 30 may determine that the expected number of collisions meets the criterion or receive an indication that the criterion is met from another device. For example, the expected number of collisions may be determined using the positioning signal timing information and the tune-away information. The number of collisions may also be determined using other DRx information for other subscriptions. The processor 30 may determine the expected number of collisions or a server external to the mobile device 10 may determine the expected number of collisions and send the expected number of collisions and/or an indication that the expected number of collisions meets the criterion to the mobile device 10.

The processor 30 may be configured to determine that the expected number of collisions meets the criterion using various techniques. In one example, the processor 30 is configured to determine, using the positioning signal timing information and the tune-away information, which positioning signals will not be received because the PRx is tuned away to a different channel. Each positioning signal that is not received is referred to as a collision. The processor 30 is configured to determine the expected number of collisions based on the identified collisions. The processor 30 is further configured to determine that the expected number of collisions is greater than a collision threshold. Alternatively or additionally, the processor 30 is configured to determine a percentage of the positioning signals that are expected to be not received by the mobile device based on the expected number of collisions exceeds a percentage threshold. The expected number of collisions may be an expected number of collisions associated with a single channel (e.g., missed positioning signals from a single base station) or an expected number of collisions from multiple channels (e.g., missed positioning signals from multiple nearby base stations). For example, the processor 30 may be configured to determine that the expected number of collisions meets the criterion when the number of collisions associated with positioning signals expected to be received from a single base station is greater than a threshold. Alternatively or additionally, the processor 30 may be configured to determine that the expected number of collisions meets the criterion when the number of collisions associated with positioning signals expected to be received from multiple base stations is greater than a threshold. Furthermore, the processor 30 may be configured to determine that the expected number of collisions meets the criterion when the expected number of received positioning signals is less than a threshold, rather than the expected number of collisions being greater than a threshold. The expected number of received positioning signals is the difference between the total number of positioning signals expected to be received and the number of expected collisions. In this way, the processor 30 is configured to ensure there is a minimum number of positioning signals available to use for determining the location of the mobile device. If the minimum number of positioning signals will not be received, then the processor 30 implements a collision-reduction measure.

The collision-reduction measure implemented by the processor 30 is a change in the operation of the mobile device 10 that results in a reduction in the expected number of collisions. For example, the processor 30 may be configured to implement the collision-reduction measure by using a second receiver, other than PRx 33, to receive at least some of the positioning signals. In some implementations, the second receiver may be the CA receiver 36. While the CA receiver 36 is conventionally used for increasing data rates for large file transfers, it may be re-purposed to receive positioning signals that would otherwise be missed by the mobile device 10 due to collisions. The CA receiver 36 may be configured to receive all of the positioning signals or just some of the positioning signals. For example, the CA receiver 36 may be configured to receive positioning signals expected not to be received by the mobile device due to the first receiver being tuned away from the first subscription, while the first receiver is configured to receive at least one other positioning signal. Thus, positioning signals that are expected to be missed by the PRx 33 due to being tuned away are received by the CA receiver 36. Alternatively, the CA receiver 36 may be configured to receive positioning signals expected not to be received by the mobile device due to the first receiver being tuned away from the first subscription and positioning signals expected to be received by the first receiver. Thus, once the expected number of collisions meets the criterion, the PRx 33 is no longer used to receive any positioning signals and only the CA receiver 36 receivers positioning signals.

The processor 30 may be configured to implement the collision-reduction measure by changing a RAT used for the second subscription. The timing of the DRx cycle of the second subscription may change in response to changing the RAT, resulting in a change in the number of collisions. The processor 30 may be configured to determine whether a different RAT is supported by the second network 21. If a different RAT is supported, the processor 30 may use the PRx 33 to access tune-away information for the different RAT (e.g., timing information for the second subscription using the different RAT). If the different RAT results in a reduction of the number of collisions, then the processor 30 changes the RAT used.

To determine whether collision-reduction measures are to be taken, the processor 30 may be configured to determine the expected collisions based on the positioning signal timing information and the tune-away information. As mentioned above, because the positioning signal schedule and the page message schedule is known in advance, the processor 30 can determine, a priori, which positioning signals will be missed by the PRx 33 due to being tuned away to a different channel. The processor 30 may be configured to make the determination of whether to implement a collision-reduction measure based on whether the identified expected collisions meet a criterion. For example, the processor 30 may be configured to determine whether a total number of collisions during a period of time for all the different channels combined meet a condition, and/or whether a number of collisions during a time period for a specific channel meet a condition. The condition may be a threshold. For example, the processor may be configured to determine, based on the identified expected collisions, whether the total number of expected collisions within a set period of time and/or the number of expected collisions on a particular channel within a set period of time is greater than a threshold. The processor 30 may determine the threshold to use based on the number of positioning signals necessary to provide a location measurement of adequate precision. For example, two positioning signals may from each base station may be adequate for determine the location of the mobile device 10. Thus, the threshold may be set at two. It is also possible that the processor 30 is configured to use a percentage, rather than a number of collisions. For example, if a base station is transmitting 18 different positioning signals in a particular time period, the processor 30 can determine a percentage of those 18 positioning signals that will be missed due to the PRx being tuned away. If that percentage is greater than a threshold, then the condition is met and the processor 30 determines that a collision-reduction measure should be implemented. The processor 30 may determine the percentage threshold to use based on the number of positioning signals necessary to provide a location measurement of adequate precision. For example, 10% of the positioning signals may be needed to adequately determine the location of the mobile device 10. Thus, the threshold may be set at ten percent.

It may not be preferred to use the CA receiver 36 to implement the collision-reduction measure because using an additional receiver consumes more power. It is more power efficient to use a collision-reduction measure that does not use the CA receiver 36 to receive positioning signals where possible. Thus, the processor 30 may be configured to determine whether a collision-reduction measure that does not use the CA receiver 36 would prevent an adequate number of collisions before resorting to a collision-reduction measure that uses the CA receiver 36. For example, if the number of collisions can be reduced below a second threshold (a threshold different from the threshold used to determine if the mobile device 10 should implement collision-reduction measures) using a collision-reduction measure that does not use the CA receiver 36 (e.g., changing the RAT used for the second subscription), then that collision-reduction measure should be used. For example, the processor 30 may be configured to determine a second expected number of collisions based on the mobile device using a second radio access technology for the second subscription, the second radio access technology being different from the first radio access technology that is currently being used by the second subscription. The processor 30 is further configured to implement the collision-reduction measure by causing the PRx receiver to use the second radio access technology for the second subscription in response to a determination that the second expected number of collisions is less than a second threshold; and causing the CA receiver 36 to receive at least some of the positioning signals in response to a determination that the second expected number of collisions is greater than the second threshold.

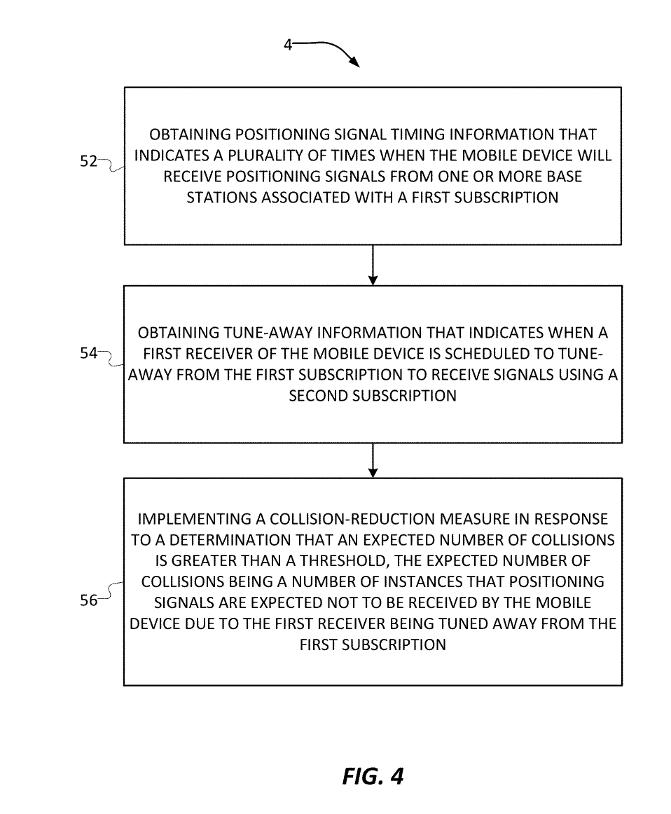

Referring to FIG. 4, with further reference to FIGS. 1-3, a method 4 of operating a mobile device 10 includes the stages shown. The method 4 can be altered, e.g., by having stages added, removed, rearranged, combined, performed concurrently, and/or having single stages split into multiple stages. For example, stage 52 described below of obtaining positioning signal timing information can be performed after stage 52. Still other alterations to the method 4 as shown and described are possible.

The method 4 includes, at stage 52, obtaining positioning signal timing information that indicates a plurality of times when the mobile device will receive positioning signals from one or more base stations associated with a first subscription to a first wireless network. The PRx 33 receives the positioning signal timing information from the primary base station 14 associated with the first subscription. The positioning signal timing information may be received as part of assistance data sent to the mobile device 10 to assist in positioning techniques, such as OTDOA or TDP. For example, the PRx 33 may receive, from the location server 15, OTDOA assistance data that provides information about the PRS expected to be received from base stations associated with the first subscription near the mobile device 10. Alternatively or additionally, the PRx 33 may receive, from a server other than the location server 15 (e.g., a third party server that stores information about the positioning signals), TDP assistance data (e.g., TDP tile information) that provides information about positioning signals being broadcast by base stations associated the first network 11 as well as positioning signals being broadcast by networks operated by a carrier other than the carrier of the first network 11. For example, if the first network 11 is a Verizon LTE network and there is a Sprint LTE network with base stations sending positioning signals near the mobile device 10, then the TDP assistance data may include information about the positioning signals of the Verizon LTE network and the positioning signals of the Sprint LTE positioning signals.

Once received via the PRx 33, the positioning signal timing information may be stored in the memory 31. The processor 30 obtains the positioning timing information by retrieving the information from the memory 31. The positioning signal timing information includes information about the timing of the positioning signals expected to be received by the mobile device 10 from multiple base stations near the mobile device 10. For example, if the positioning signals are PRS, the positioning signal timing information, may include the periodicity, T; the PRS duration, w; and the sub-frame offset, ΔPRS for multiple base stations near the mobile device 10.

The method 4 includes, at stage 54, obtaining tune-away information that indicates when a first receiver of the mobile device is scheduled to tune-away from the first subscription to receive signals using a second subscription to a second wireless network. The first receiver may be the PRx 33, which receives the tune-away information from the primary base station 25 associated with the second subscription. The tune-away information may be received by the PRx 33 while establishing a connection with a base station associated with the second subscription. The tune-away information may be timing information about the DRX cycle for the idle second subscription.

Once received via the PRx 33, the positioning signal timing information may be stored in the memory 31 and the processor 30 obtains the tune-away information by retrieving the information from the memory 31. The tune-away information includes information about the timing of the page messages expected to be received by the mobile device 10 from the primary base station 25 for the second network 21. By way of example and not limitation, the tune-away information may include information about the periodicity, duration and offset of page messages expected to be received from a base station for the second network 21.

The method 4 includes, at stage 56, implementing a collision-reduction measure in response to an expected number of collisions meeting a criterion, the expected number of collisions being a number of instances that positioning signals are expected not to be received by the mobile device based on the positioning signal timing information and the tune-away information. Implementing the collision-reduction measure results in an actual number of collisions that is less than the expected number of collisions. The collision-reduction measure is a change in the operation of the mobile device 10 that results in a reduction in the expected number of collisions. For example, the processor 30 implements the collision-reduction measure using a second receiver, different from the PRx 33, to receive at least some of the positioning signals. In some implementations, the second receiver is the CA receiver 36. The CA receiver 36 receive all of the positioning signals or just some of the positioning signals. For example, the CA receiver 36 may receive positioning signals expected not to be received by the mobile device due to the first receiver being tuned away from the first subscription, while the first receiver receives at least one other positioning signal. For example, the first receiver may receive all the positioning signals not expected to result in a collision. Thus, only the positioning signals that are expected to be missed by the PRx 33 due to being tuned away are received by the CA receiver 36. Alternatively, the CA receiver 36 may receive positioning signals expected not to be received by the mobile device due to the first receiver being tuned away from the first subscription and positioning signals expected to be received by the first receiver. Thus, once the expected number of collisions meets the criterion, the PRx 33 is no longer used to receive any positioning signals and only the CA receiver 36 receivers positioning signals.

Optionally, the method may include determining that the expected number of collisions meets the criterion using various techniques. In one example, the processor 30 determines, using the positioning signal timing information and the tune-away information, which positioning signals will not be received because the PRx is tuned away to a different channel. The processor 30 determines the expected number of collisions based on the identified collisions. The processor 30 further determines that the expected number of collisions is greater than a collision threshold. Alternatively or additionally, the processor 30 determines a percentage of the positioning signals that are expected to be not received by the mobile device based on the expected number of collisions exceeds a percentage threshold. The expected number of collisions may be an expected number of collisions associated with a single channel (e.g., missed positioning signals from a single base station) or an expected number of collisions from multiple channels (e.g., missed positioning signals from multiple nearby base stations). For example, the processor 30 may determine that the expected number of collisions meets the criterion when the number of collisions associated with positioning signals expected to be received from a single base station is greater than a threshold. Alternatively or additionally, the processor 30 may determine that the expected number of collisions meets the criterion when the number of collisions associated with positioning signals expected to be received from multiple base stations is greater than a threshold. Furthermore, the processor 30 may determine that the expected number of collisions meets the criterion when the expected number of received positioning signals is less than a threshold, rather than the expected number of collisions being greater than a threshold. The expected number of received positioning signals is the difference between the total number of positioning signals expected to be received and the number of expected collisions. In this way, the processor 30 ensures there is a minimum number of positioning signals available to use for determining the location of the mobile device. If the minimum number of positioning signals will not be received, then the processor 30 implements a collision-reduction measure.

The processor 30 may implement the collision-reduction measure by changing a RAT used for the second subscription. By changing the RAT, the timing of the DRX cycle of the second subscription may change, resulting in a change in the number of collisions. The processor 30 may determine whether a different RAT is supported by both the mobile device 10 and the second network 21. If a different RAT is supported, the processor 30 uses the PRx 33 to access tune-away information for the different RAT (e.g., timing information for the DRx cycle for the paging messages of the second subscription using the different RAT). If the different RAT results in a reduction of the number of collisions, then the processor 30 changes the RAT used by the mobile device 10 to the different RAT.

To determine whether collision-reduction measures are to be taken, the processor 30 determines the expected collisions based on the positioning signal timing information and the tune-away information. Because the positioning signal schedule and the page message schedule is known in advance, the processor 30 can determine, a priori, which positioning signals will be missed by the PRx 33 due to being tuned away. The processor 30 determines whether to implement a collision-reduction measure based on whether the identified expected collisions meet a condition. For example, the processor 30 may determine whether a total number of collisions during a period of time for all the different channels combined meet a condition, and/or whether a number of collisions during a time period for a specific channel meet a condition. The condition may be a threshold. For example, the processor may to determine, based on the identified expected collisions, whether the total number of expected collisions within a set period of time and/or the number of expected collisions on a particular channel within a set period of time is greater than a threshold. The processor 30 may determine the threshold to use based on the number of positioning signals necessary to provide a location measurement of adequate precision. For example, two positioning signals may from each base station may be adequate for determine the location of the mobile device 10. Thus, the threshold may be set at two. It is also possible that the processor 30 uses a percentage, rather than a number of collisions in making the determination whether to implement a collision-reduction measure. For example, if a base station is transmitting 18 different positioning signals in a particular time period, the processor 30 can determine a percentage of those 18 positioning signals that will be missed due to the PRx being tuned away. If that percentage is greater than a threshold, then the condition is met and the processor 30 determines that a collision-reduction measure should be implemented. The processor 30 may determine the percentage threshold to use based on the number of positioning signals necessary to provide a location measurement of adequate precision. For example, 10% of the positioning signals may be needed to adequately determine the location of the mobile device 10. Thus, the threshold may be set at ten percent.

It may not be preferred to use the CA receiver 36 to implement the collision-reduction measure because using an additional receiver consumes more power. It is more power efficient to use a collision-reduction measure that does not use the CA receiver 36 to receive positioning signals where possible. Thus, the processor 30 determines whether a collision-reduction measure that does not use the CA receiver 36 would prevent an adequate number of collisions before resorting to a collision-reduction measure that uses the CA receiver 36. For example, if the number of collisions can be reduced below a second threshold (a threshold different from the threshold used to determine if the mobile device 10 should implement collision-reduction measures) using a collision-reduction measure that does not use the CA receiver 36 (e.g., changing the RAT used for the second subscription), then that collision-reduction measure should be used. For example, the processor 30 may determine a second expected number of collisions based on the mobile device using a second radio access technology for the second subscription, the second radio access technology being different from the first radio access technology that is currently being used by the second subscription. The processor 30 implements the collision-reduction measure by causing the PRx receiver to use the second radio access technology for the second subscription in response to a determination that the second expected number of collisions is less than a second threshold; and causing the CA receiver 36 to receive at least some of the positioning signals in response to a determination that the second expected number of collisions is greater than the second threshold.

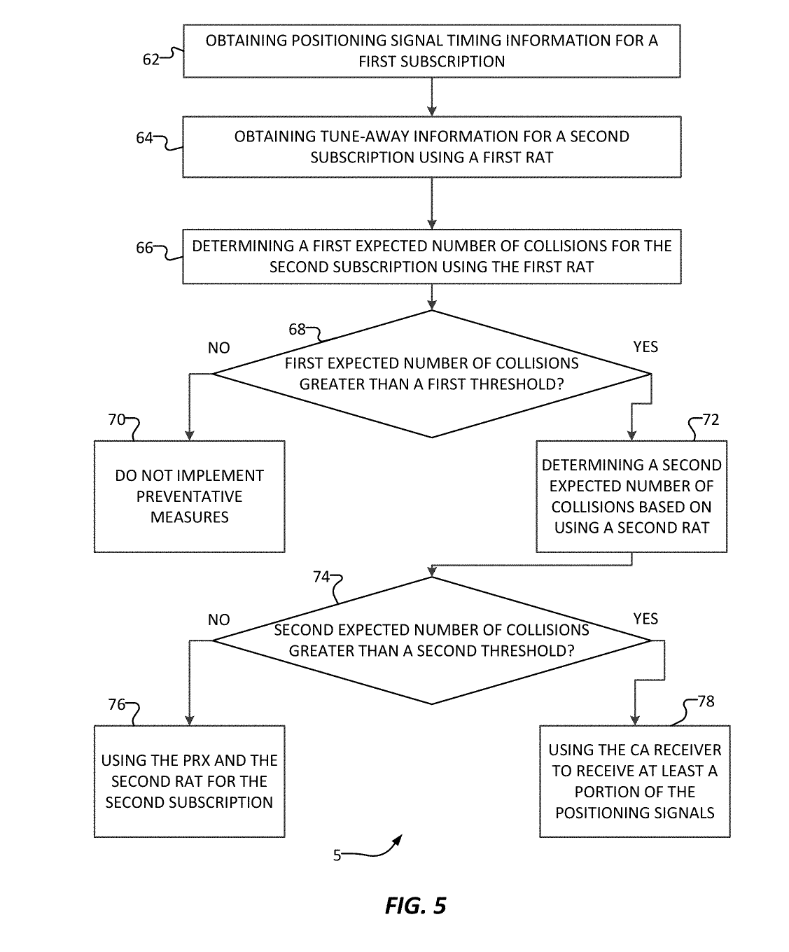

Referring to FIG. 5, with further reference to FIGS. 1-4, a method 5 of operating a mobile device 10 includes the stages shown. The method 5 can be altered, e.g., by having stages added, removed, rearranged, combined, performed concurrently, and/or having single stages split into multiple stages. For example, stage 62 described below of obtaining positioning signal timing information can be performed after stage 64. Still other alterations to the method 4 as shown and described are possible.

The method 5 includes, at stage 62, obtaining positioning signal timing information for a first subscription. Stage 62 may be performed in a similar manner as stage 52 of FIG. 4. The processor 30 may obtain the positioning signal timing information from the memory 31. The PRx 33 may have previously received and stored the positioning signal timing information in the memory 31. The positioning signal timing information may be received by the PRx 33 as part of the assistance data used for performing a positioning technique. The positioning signal timing information may provide indications about the timing of the positioning signals expected to be received from a plurality of base stations associated with the first subscription. For example, the positioning signal timing information may include an indication of the periodicity, duration and/or offset of the positioning signals.

The method 5 includes, at stage 64, obtaining tune-away information for a second subscription using a first RAT. Stage 64 may be performed in a similar manner as stage 54 of FIG. 4. The processor 30 may obtain the tune-away information from the memory 31. The PRx 33 may have previously received and stored the tune-away information in the memory 31. The PRx 33 may obtain the tune-away information when a connection to a second network using the second subscription is established. The tune-away information may include timing information about the DRx cycle of the second subscription's connection. For example, the tune-away information may include an indication of the periodicity, duration and/or offset of the page messages expected to be received by the PRx 33 while the second subscription is in idle mode.

The method 5 includes, at stage 66, determining a first expected number of collisions for the second subscription using the first RAT. As described above, the expected number of collisions may be determined, a priori, based on the positioning signal timing information and the tune-away information. The first expected number of collisions may be the number of collisions expected on a single channel of the first subscription, or sum of the total number of collisions on all channels on the first subscription.

The method 5 includes, at stage 68, determining if the first expected number of collisions is greater than a first threshold. If the first expected number of collisions is not greater than a first threshold, then the method 5 continues to stage 70, where the mobile device 10 operates conventionally without implementing any collision-reduction measures to reduce collisions. If the first expected number of collisions is greater than a first threshold, then the method 5 continues to stage 72, where the method 5 includes determining a second expected number of collisions based on using a second RAT. To make this determination, the processor 30 obtains tune-away information for the second subscription based on using a second RAT, different from the first RAT.

As mentioned above, different RATs have different DRx cycles. Thus, the collisions may be reduced simply by changing the RAT of the idle, second subscription. However, before changing the RAT used for the second subscription, the processor 30 determines the result of such a change to determine if it is an adequate collision-reduction measure. Thus, at stage 74, the method 5 includes determining whether the second expected number of collisions is greater than a second threshold. The second threshold may be different from the first threshold, but should be equal to or less than the first threshold. This is because the goal of changing the RAT used for the second subscription is not necessarily to resolve completely the issues caused by the collisions, but to mitigate the effects of the collisions. Thus, some reduction in the number of collisions is desired.

If the second expected number of collisions is not greater than a second threshold, this indicates that changing the RAT used for the second subscription adequately resolves the issues caused by the collisions. Therefore, the method 5 continues to stage 76 where the processor 30 uses the PRx 33 and the second RAT for the second subscription. The processor 30 controls the PRx 33 to change the RAT from the first RAT to the second RAT and continue operating the second subscription in idle mode, but with paging messages being received at different times that cause fewer collisions than if the first RAT was used.

If the second expected number of collisions is greater than a second threshold, this indicates that changing the RAT used for the second subscription does not reduce the number of collisions enough. While changing RATs is the preferred collision-reduction measure, if it does not adequately prevent collisions, collision-reduction measures that are less power efficient are used. Therefore, the method 5 continues to stage 78, where the processor 30 uses the CA receiver 36 to receive at least some of the positioning signals. As discussed above, the CA receiver 36 can be used to receive all the positioning signals for the first subscription or only the positioning signals that would not be received due to the PRx 33 tuning away to receive page messages on the second subscription.

### Other Considerations

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

A wireless network is a communication system in which communications are conveyed wirelessly, i.e., by electromagnetic and/or acoustic waves propagating through atmospheric space rather than through a wire or other physical connection. A wireless network may not have all communications transmitted wirelessly, but is configured to have at least some communications transmitted wirelessly.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions.

The processes, systems, and devices discussed above are examples. Various configurations may omit, substitute, or add various procedures or components as appropriate. For instance, in alternative configurations, the processes may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed is:

1. A method of operating a mobile device, the method comprising:
obtaining positioning signal timing information that indicates a plurality of times when the mobile device will receive positioning signals from one or more base stations associated with a first subscription to a first wireless network;
obtaining tune-away information that indicates when a first receiver of the mobile device is scheduled to tune away from the first subscription to receive signals using a second subscription to a second wireless network; and
implementing a collision-reduction measure in response to an expected number of collisions meeting a criterion, wherein the expected number of collisions is a number of instances that positioning signals are expected not to be received by the mobile device based on the positioning signal timing information and the tune-away information.

2. The method of claim 1, wherein implementing the collision-reduction measure comprises using a second receiver, separate from the first receiver, to receive at least some of the positioning signals.

3. The method of claim 2, wherein using the second receiver to receive at least some of the positioning signals comprises receiving at least some of the positioning signals with a carrier aggregation receiver.

4. The method of claim 2, wherein using the second receiver to receive at least some of the positioning signals comprises receiving, with the second receiver, positioning signals expected not to be received by the mobile device due to the first receiver being tuned away from the first subscription, and wherein the method further comprises receiving at least one other positioning signal with the first receiver.

5. The method of claim 2, wherein using the second receiver to receive at least some of the positioning signals comprises receiving, with the second receiver, positioning signals expected not to be received by the mobile device due to the first receiver being tuned away from the first subscription and positioning signals expected to be received by the first receiver.

6. The method of claim 1, wherein obtaining the tune-away information comprises receiving discontinuous reception cycle information for the second subscription.

7. The method of claim 1, wherein implementing the collision-reduction measure comprises using a radio access technology for the second subscription other than a radio access technology for which the tune-away information is obtained.

8. The method of claim 1, wherein:
the expected number of collisions is a first expected number of collisions for use of a first radio access technology for the second subscription;
the expected number of collisions meeting the criterion includes the expected number of collisions being greater than a first threshold;
and
implementing the collision-reduction measure comprises:
using the first receiver and a second radio access technology, different from the first radio access technology, for the second subscription in response to a second expected number of collisions, expected if the mobile device uses the second radio access technology for the second subscription, being less than a second threshold; and
receiving at least some of the positioning signals with a second receiver, separate from the first receiver, in response to the second expected number of collisions being greater than the second threshold.

9. A mobile device comprising:
a first receiver configured to wirelessly receive signals from a first wireless network using a first subscription and/or a second wireless network using a second subscription;
a processor, communicatively coupled to the first receiver, configured to:
obtain positioning signal timing information that indicates a plurality of times when the mobile device will receive positioning signals from one or more base stations associated with the first subscription to the first wireless network;
obtain tune-away information that indicates when the first receiver of the mobile device is scheduled to tune away from the first subscription to receive signals using a second subscription to the second wireless network; and
implement a collision-reduction measure in response to an expected number of collisions meeting a criterion, wherein the expected number of collisions is a number of instances that positioning signals are expected not to be received by the mobile device based on the positioning signal timing information and the tune-away information.

10. The mobile device of claim 9, further comprising a second receiver, separate from the first receiver, wherein the processor is configured to implement the collision-reduction measure by using the second receiver to receive at least some of the positioning signals.

11. The mobile device of claim 10, wherein the second receiver comprises a carrier aggregation receiver.

12. The mobile device of claim 10, wherein the second receiver is configured to receive positioning signals expected not to be received by the mobile device due to the first receiver being tuned away from the first subscription, and wherein the first receiver is configured to receive at least one other positioning signal.

13. The mobile device of claim 10, wherein the second receiver is configured to receive positioning signals expected not to be received by the mobile device due to the first receiver being tuned away from the first subscription and positioning signals expected to be received by the first receiver.

14. The mobile device of claim 9, wherein the processor is configured to obtain the tune-away information by receiving discontinuous reception cycle information for the second subscription.

15. The mobile device of claim 9, wherein the processor is configured to implement the collision-reduction measure by using a radio access technology for the second subscription other than a radio access technology for which the tune-away information is obtained.

16. The mobile device of claim 9, wherein:
the expected number of collisions is a first expected number of collisions for use of a first radio access technology for the second subscription;
the expected number of collisions meeting the criterion includes the expected number of collisions being greater than a first threshold; and
the processor is further configured to implement the collision-reduction measure by:
causing the first receiver to use a second radio access technology, different from the first radio access technology, for the second subscription in response to a second expected number of collisions, expected if the mobile device uses the second radio access technology for the second subscription, being less than a second threshold; and
causing a second receiver, separate from the first receiver, to receive at least some of the positioning signals in response to the second expected number of collisions being greater than the second threshold.

17. A mobile device comprising:
a first receiving means for wirelessly receiving signals from a first wireless network using a first subscription and/or a second wireless network using a second subscription;
timing obtaining means for obtaining positioning signal timing information that indicates a plurality of times when the mobile device will receive positioning signals from one or more base stations associated with a first subscription to the first wireless network;
tune-away obtaining means for obtaining tune-away information that indicates when the first receiving means of the mobile device is scheduled to tune away from the first subscription to receive signals using a second subscription to the second wireless network; and
prevention means for implementing a collision-reduction measure in response to an expected number of collisions meeting a criterion, wherein the expected number of collisions is a number of instances that positioning signals are expected not to be received by the mobile device based on the positioning signal timing information and the tune-away information.

18. The mobile device of claim 17, further comprising a second receiving means, separate from the first receiving means, wherein the prevention means implements the collision-reduction measure using the second receiving means to receive at least some of the positioning signals.

19. The mobile device of claim 18, wherein the second receiving means comprises a carrier aggregation receiving means.

20. The mobile device of claim 18, wherein the second receiving means is for receiving positioning signals expected not to be received by the mobile device due to the first receiving means being tuned away from the first subscription, and wherein the first receiving means receives at least one other positioning signal.

21. The mobile device of claim 18, wherein the second receiving means is for receiving positioning signals expected not to be received by the mobile device due to the first receiving means being tuned away from the first subscription and positioning signals expected to be received by the first receiving means.

22. The mobile device of claim 17, wherein the prevention means comprises radio-access-technology means for using a radio access technology for the second subscription other than a radio access technology for which the tune-away information is obtained.

23. The mobile device of claim 17, wherein:
the expected number of collisions is a first expected number of collisions for use of a first radio access technology for the second subscription;
the expected number of collisions meeting the criterion includes the expected number of collisions being greater than a first threshold; and
the prevention means is further for:
causing the first receiving means to use a second radio access technology, different from the first radio access technology, for the second subscription in response to a second expected number of collisions, expected if the mobile device uses the second radio access technology for the second subscription, being less than a second threshold; and
causing a second receiving means, separate from the first receiving means, to receive at least some of the positioning signals in response to a determination that the second expected number of collisions being greater than the second threshold.

24. A non-transitory, processor-readable storage medium comprising processor-readable instructions configured to cause a processor of a device to:
obtain positioning signal timing information that indicates a plurality of times when the mobile device will receive positioning signals from one or more base stations associated with a first subscription to a first wireless network;
obtain tune-away information that indicates when a first receiver of the mobile device is scheduled to tune away from the first subscription to receive signals using a second subscription to a second wireless network; and
implement a collision-reduction measure in response to an expected number of collisions meeting a criterion, wherein the expected number of collisions is a number of instances that positioning signals are expected not to be received by the mobile device based on the positioning signal timing information and the tune-away information.

25. The non-transitory, processor-readable storage medium of claim 24, wherein the instructions configured to cause the processor to implement the collision-reduction measure comprise instructions configured to cause the processor to use a second receiver, separate from the first receiver, to receive at least some of the positioning signals.

26. The non-transitory, processor-readable storage medium of claim 25, wherein the instructions configured to cause the processor to use a second receiver to receive at least some of the positioning signals comprise instructions configured to cause the processor to receive at least some of the positioning signals with a carrier aggregation receiver.

27. The non-transitory, processor-readable storage medium of claim 25, wherein the instructions configured to cause the processor to use a second receiver to receive at least some of the positioning signals comprise instructions configured to cause the processor to receive, with the second receiver, positioning signals expected not to be received by the mobile device due to the first receiver being tuned away from the first subscription, and wherein the non-transitory, processor-readable storage medium further comprises instructions configured to cause the processor to receive at least one other positioning signal with the first receiver.

28. The non-transitory, processor-readable storage medium of claim 25, wherein the instructions configured to cause the processor to use a second receiver to receive at least some of the positioning signals comprise instructions configured to cause the processor to receive, with the second receiver, positioning signals expected not to be received by the mobile device due to the first receiver being tuned away from the first subscription and positioning signals expected to be received by the first receiver.

29. The non-transitory, processor-readable storage medium of claim 24, wherein the instructions configured to cause the processor to implement the collision-reduction measure comprise instructions configured to cause the processor to use a radio access technology for the second subscription other than a radio access technology for which the tune-away information is obtained.

30. The non-transitory, processor-readable storage medium of claim 24, wherein:
the expected number of collisions is a first expected number of collisions for use of a first radio access technology for the second subscription;
the expected number of collisions meeting the criterion includes the expected number of collisions being greater than a first threshold; and
the instructions configured to implement the collision-reduction measure comprise:
instructions configured to cause the processor to use the first receiver and a second radio access technology, different from the first radio access technology, for the second subscription in response to a second expected number of collisions, expected if the mobile device uses the second radio access technology for the second subscription, being less than a second threshold; and
instructions configured to cause the processor to receive at least some of the positioning signals with a second receiver, separate from the first receiver, in response to the second expected number of collisions being greater than the second threshold.
